(19) United States
(12) Patent Application Publication
(10) Pub. No.: US 2022/0174927 A1
(43) Pub. Date: Jun. 9, 2022

(54) FISHING LURE PROTECTIVE CASE

(71) Applicant: William B. Weller, Plantation, FL (US)

(72) Inventor: William B. Weller, Plantation, FL (US)

(21) Appl. No.: 17/547,059

(22) Filed: Dec. 9, 2021

Related U.S. Application Data
(60) Provisional application No. 63/123,196, filed on Dec. 9, 2020.

(51) Int. Cl. A01K 97/06

(52) U.S. Cl. CPC A01K 97/06

(57) ABSTRACT

A protective case for a fishing lure allows the fishing lure to remain attached to a fishing line on a fishing rod and protects the lure from damage. The case also prevents hooks on the fishing lure from inadvertently cutting or hurting the user or other objects during transport. The fishing lure protective case forms a shell around the fishing lure and includes a small opening at one end to accommodate the fishing line onto which the lure is attached. The protective case is secured to the fishing rod by placing a hook on the case into one of the guides on the rod.

### CROSS-REFERENCE TO RELATED APPLICATIONS

This application claims priority to U.S. Provisional Application Ser. No. 63/123,196 filed on Dec. 9, 2021, the contents of which are incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to a protective case for a fishing lure. More particularly, the invention relates to a protective case that encloses a fishing lure while it is still attached to a fishing line on a rod and securely stores the lure in a way that protects it from damage and prevents hooks on the lure from engaging other objects.

### Description of the Related Art

Properly attaching a lure to a fishing line can be time-consuming and tedious. Thus, when a fisher has a preferred fishing lure, he or she often does not remove the lure from a fishing line when the fishing rod is not in use. In addition, professional sports fishers typically utilize several fishing rods, each with a different lure. However, fishing lures have at least one sharp hook that can be dangerous. Leaving a fishing lure on a fishing rod when not in use can result in inadvertent injury. The rods and lines are also easily tangled. One common method of storing a fishing lure on a fishing rod is to simply hook one of the hooks of the fishing lure onto one of the guides on the rod. However, this still leaves the hooks on the lure exposed and capable of causing damage or injury. They are also more likely to get tangled with other fishing equipment. While some attempts have been made to provide devices for covering lures on a fishing rod, they suffer from many disadvantages. They are often overly complex, too flimsy, easily warp, or do not prevent damage to the lure.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a durable protective case for securing a fishing lure attached to a fishing line on a fishing rod.

### BRIEF SUMMARY OF THE INVENTION

Disclosed is a protective case for a fishing lure that allows the fishing lure to remain attached to a fishing line on a fishing rod and protects the lure from damage. The case also prevents hooks on the fishing lure from inadvertently cutting or hurting the user or other objects during transport. The fishing lure protective case forms a shell around the fishing lure and includes a small opening at one end to accommodate the fishing line onto which the lure is attached. The protective case is secured to the fishing rod by placing a hook on the case into one of the guides on the rod.

In one embodiment, a fishing lure protective case has an ovoid shell formed from two sections connected by at least one rotating hinge on a first side and a releasable lock on a second side. An opening is located at a distal end of the ovoid shell and sized to admit a fishing line and formed when the two sections of the shell. A hook for on the ovoid shell engages a line guide on the rod. The ovoid shell may include a plurality of openings that allow water to drain and are too small to admit a fishhook, and may be transparent.

In one embodiment, the fishing lure protective case has an ovoid shell formed from a rigid material and the hinge comprises an elongate sheet of the same rigid material formed thin in order to be flexible. The hook may be located at a distal end of the ovoid shell or on the hinge.

It is therefore an object of the present invention to provide a fishing lure protective case formed from two sections capable of attaching to a guide on a fishing rod and preventing damage or injury to the fishing lure or objects in its immediate environment.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side plan view of a fishing lure protective case in an open position in accordance with the principles of the invention;

FIG. 2 is a side plan view of a fishing lure protective case in a closed position in accordance with the principles of the invention;

FIG. 3 is a proximal view of a fishing lure protective case in a closed position in accordance with the principles of the invention;

FIG. 4 is a distal view of a fishing lure protective case in a closed position in accordance with the principles of the invention;

FIG. 5 is a side plan view of another alternative embodiment of a fishing lure protective case having drainage openings in an open position in accordance with principles of the invention;

FIG. 6 is a side plan view of another alternative embodiment of a fishing lure protective case having to hooks in an open position in accordance with principles of the invention;

FIG. 7 is a side plan view of another alternative embodiment of a fishing lure protective case having a hook attached to the hinge in a closed position in accordance with the principles of the invention;

FIG. 8 is a perspective view of another alternative embodiment of a fishing lure protective case in an open position in accordance with principles of the invention;

FIG. 9 is another perspective view of another alternative embodiment of a fishing lure protective case in an open position in accordance with principles of the invention;

FIG. 10 is a cross-sectional view of a hook for a fishing lure protective case in a retracted position in accordance with principles of the invention;

FIG. 11 is a cross-sectional view of a hook for a fishing lure protective case in an extended position in accordance with principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise. “Proximal” and “proximal direction” denote the end of the device facing the operator of a fishing pole. “Distal” and “distal direction” denote the end of the device facing away from the operator of fishing pole. “Longitudinal” refers to a direction substantially parallel to a fishing rod to which a protective case is attached.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Disclosed is a protective case for a fishing lure that allows the fishing lure to remain attached to a fishing line on a fishing rod and protects the lure from damage. The case also prevents hooks on the fishing lure from inadvertently cutting or hurting the user or other objects during transport. The fishing lure protective case forms a shell around the fishing lure and includes a small opening at one end to accommodate the fishing line onto which the lure is attached. The protective case is secured to the fishing rod by placing a hook on the case into one of the guides on the rod.

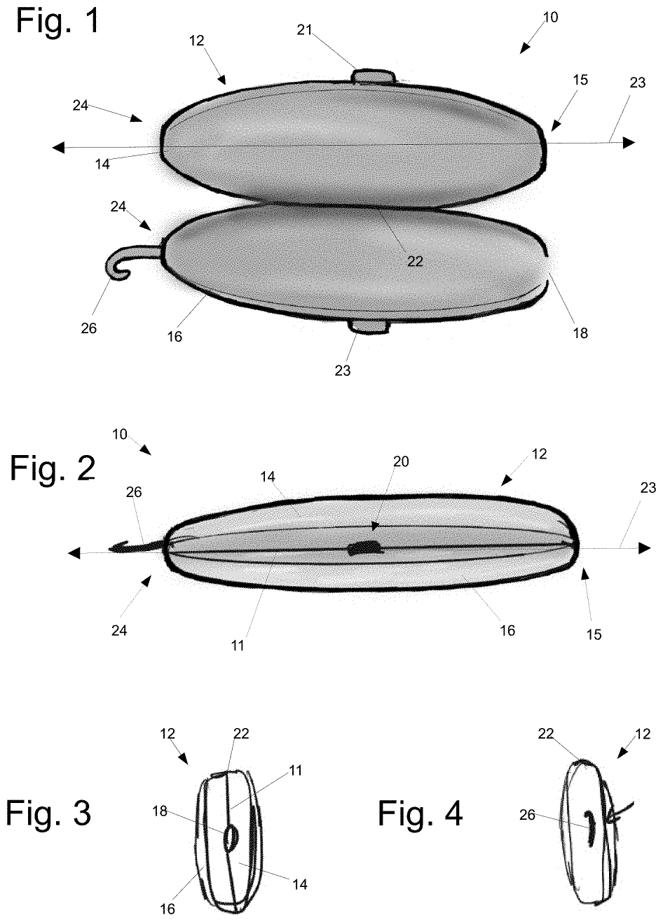

FIGS. 1-4 show an exemplary embodiment of a fishing lure protective case 10 in accordance with the principles of the invention. The protective case 10 has an ovoid protective shell 12 extending from a distal end 15 to a proximal end 24 along a longitudinal axis 23. The protective shell 12 is formed from a first section 14 and a second section 16, separated by a seam 11 that defines the edges of the two sections 14 and 16. FIG. 1 shows the ovoid shell 12 in the open position while FIGS. 2-4 show the shell in the closed position. A proximal end 15 of the shell has an opening 18 that allows a typical fishing line to which a fishing lure is attached to pass from the outside to the inside of the case 10. The opening 18 is preferably sized to accommodate fishing lines of different sizes. Complementary components 21 and 23 of a locking mechanism 20 are located along the edges of the shell sections 14 and 16. A locking mechanism 20 is located on the seam 11 substantially opposite to a hinge 22 about which the sections 14 and 16 rotate to open and close the case 10. A hook 26 extends in a distal direction from the distal end of the second section 16. In this embodiment, the hook 26 lies substantially within a plane defined by the seam 11.

In use, a fishing lure is placed within the case and the sections 14 and 16 are folded over each other and secured closed by the locking mechanism 20. The hook 26 is then affixed to one of the guides of a fishing rod and the fishing line is wound to create sufficient tension to secure the hook 26 to the guide on the rod. The case 10 preferably includes a plurality of openings to allow water to drain from the fishing lure inside the case. The sections 14 and 16 preferably are transparent or include at least a portion that is transparent. Sections 14 and 16 are also preferably formed from a rigid material to prevent damage to the lure.

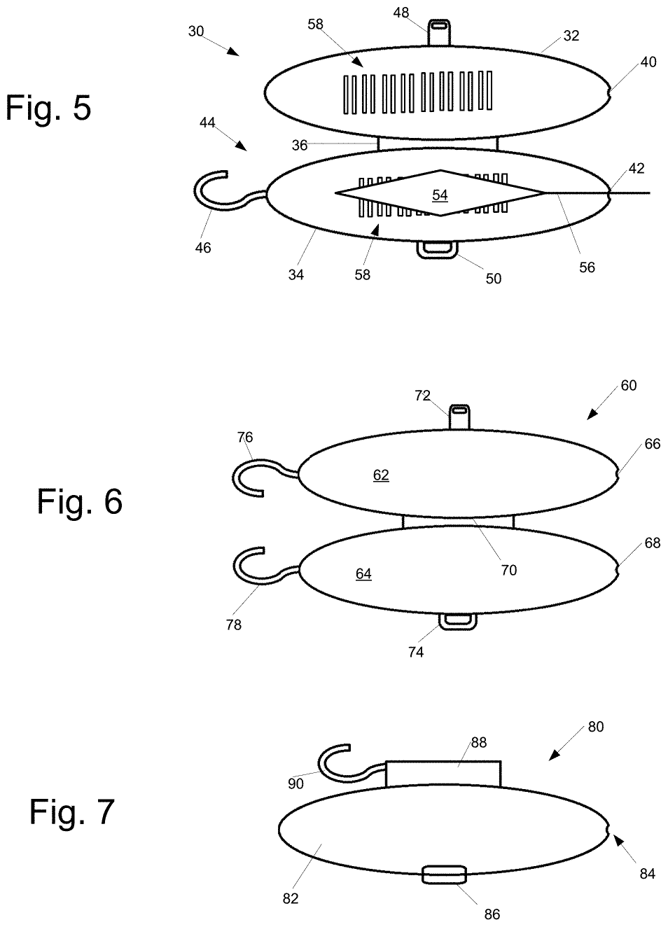

FIG. 5 shows an alternative embodiment of a fishing lure protective case 30 in accordance with principles of the invention. In this embodiment, the case 30 has an ovoid shell comprised of two sections 32 and 34 connected by a hinge 36 formed from a flexible sheet of material. The proximal ends 38 of the sections 32 and 34 include small indentations 40 and 42 that form a small opening to accommodate the fishing line when the case 30 is closed. The distal end 44 of the section 34 includes a hook 46 for attachment to a guide on a rod. In this embodiment, the entire case is formed from a single piece of plastic, with the sections 32 and 34 being thicker to make them rigid while the hinge 36 is then enough for it to be flexible. The locking mechanism is formed by the complementary tab 48 and slot 50 which are also made from the same plastic material, such as for example high density polyethylene or high-density polypropylene. A lure 54 is shown with in the case 30. When the lure 54 is placed in one of the sections 32 or 34, the fishing line 56 is placed within one of the indentations 40 or 42 prior to folding the other section over and engaging the locking mechanism. Both sections 32 and 34 include a plurality of drainage openings 58 that allow water to drain from the lure 54 inside the case 30. In this embodiment, the drainage openings 58 are rectangular slots. Those skilled in the art will appreciate that the openings could be circular, oval or have any other suitable configuration and be arranged in any desirable manner.

FIG. 6 shows another alternative embodiment of a fishing lure protective case 60 in accordance with the principles of the invention. In this embodiment, the case 60 is formed from two sections 62 and 64 that fold together to provide an ovoid shell. The rims, or edges, of the sections 62 and 64 include proximal indentations 66 and 68, respectively, which form an opening that allows fishing line to pass through the shell. They are connected on one side by a hinge 70 and include a locking mechanism also formed by a tab 72 and slot 74. In this embodiment, there are two hooks 76 and 78 extending from the distal ends of the sections 62 and 64, respectively. The inclusion of a hook for each section provides added durability and prevents the sections from warping or bending due to proximal stress applied to only one of the two sections of the case 60. Those skilled in the art will appreciate that over time rigid and semirigid materials such as plastics can warp or deform. This is particularly true when a force is applied for long periods, especially in the heat such as is often encountered when fishing. The use of two hooks improves the lifespan and durability of a fishing lure protective case even when it is made from relatively inexpensive materials. The use of two hooks also provides added stability and reduces the likelihood that the protective case will come loose inadvertently.

FIG. 7 shows another alternative embodiment of a fishing lure protective case 80 in accordance with principles of the invention. Protective case 80 is shown in the closed position which forms an ovoid shell 82. The shell 82 includes a proximal opening 84 for the fishing line, and a locking mechanism 86. The hinge 88 of the protective case 80 is larger than the hinges shown in previous exemplary embodiments. The hook 90 of this embodiment extends from the hinge 88 instead of the ovoid shell 82. This configuration may be desirable for storing relatively large fishing lures and makes the hook 90 less obstructed by the shell 82 itself, which may make it easier to engage and disengage from a guide of a fishing rod.

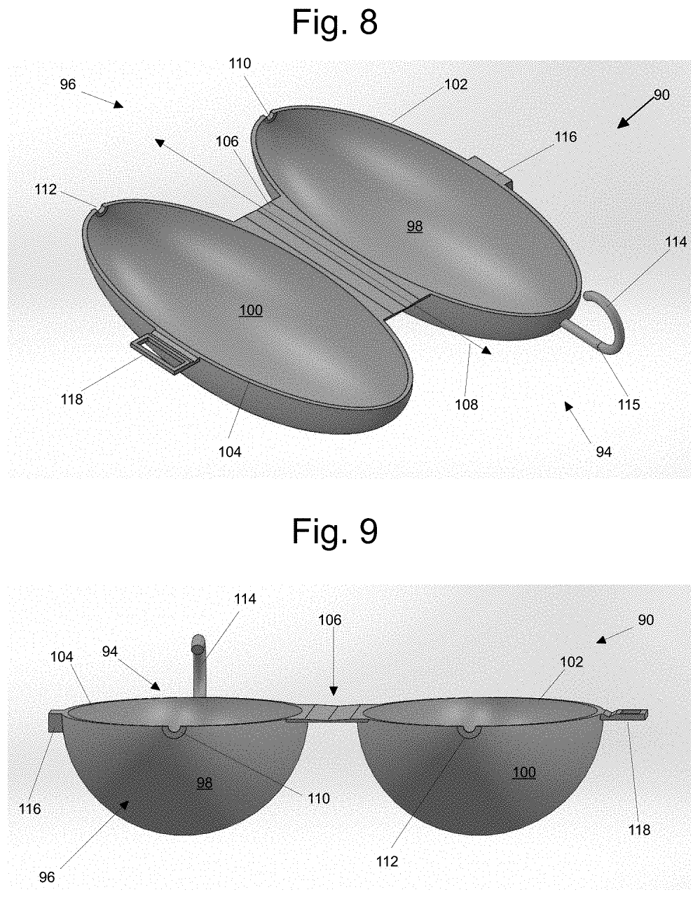

FIGS. 8 and 9 show another alternative embodiment of a fishing lure protective case 90 in accordance with principles of the invention. The protective case 90 extends from a proximal end 94 to a distal end 96. The case 90 is formed by a first section 98 and a second section 100 that are substantially symmetric and configured to join along their edges 102 and 104, respectively. The first section 98 and second section 100 are connected by a hinge 106 having an axis of rotation 108 which lies within a longitudinal seam defined by the edges 102 and 104 of the two opposing sections when the protective case 90 is in the closed position. In this embodiment, the entire protective case 90 is formed from a single, unitary piece of material. The hinge 106 allows the two sections 98 and 100 of the protective case 92 translate between an open position and a closed position.

The edges 102 and 104 of the sections 98 and 100 include indentations 110 and 112 at their distal ends 94 to accommodate a fishing line to which a protected fishing lure is attached. A hook 114 extends from the proximal end of the second section 98. In this embodiment, the hook 114 lies in a plane substantially perpendicular to the plane formed by the edge 102. The first section 98 also includes a tab 116 along its edge 102 opposite to the hinge 106. A slot 118, which is complementary to the tab 116, extends from the edge 104 of the second section 100 opposite to the hinge 106. Together, tab 116 and slot 118 form a locking mechanism that allows the two sections 98 and 100 to be releasably secured in a locked position to enclose a fishing lure. The hook 114 of this embodiment may optionally be rotatable about a pivoting hinge 115.

The above-described protective cases for fishing lures remain attached to a line guide of a fishing rod so long as there is sufficient tension in the fishing line. However, if the fishing line for any reason become slack, there is a chance that the hook will disengage from the line guide. When moving or storing fishing rods with the fishing were protective case attached, there is a possibility that the fishing rod will be bent, thereby creating slack in the fishing line. As a result, the fishing lure protective case may inadvertently and unexpectedly detach from the line guide.

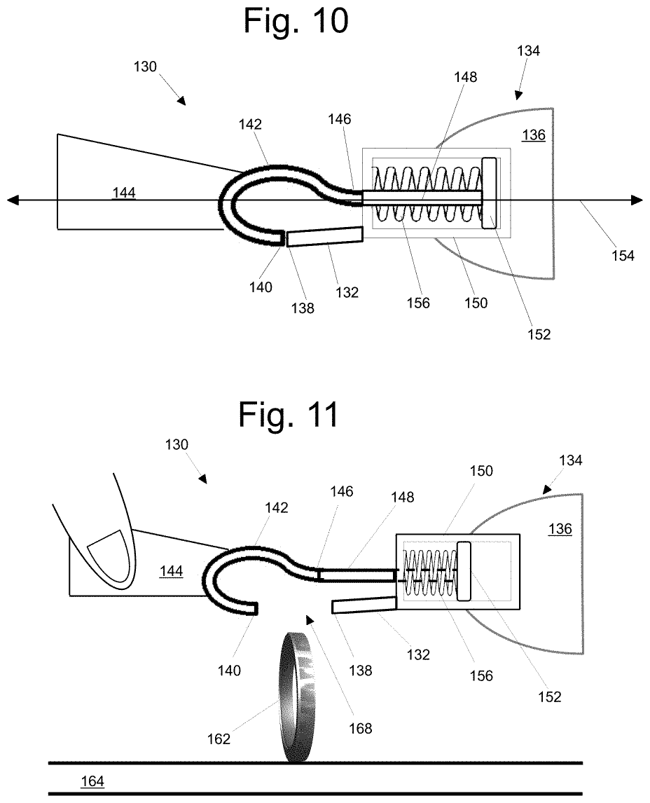

FIGS. 10 and 11 show an alternative embodiment for a hook 130 for use with a fishing lure protective case in accordance with principles of the invention. The hook 130 prevents the protective case 136 of the invention from becoming detached from a line guide when there is slack in the fishing line. The hook 130 may be used with any of the previously described embodiments, as well as other embodiments contemplated and within the spirit and scope of the invention.

Hook 130 includes a restraining bar 132 that extends in a proximal direction from the proximal end 134 of a protective case 136 in a proximal direction such that the tip 138 of the restraining bar 132 is adjacent to or abuts the tip 140 of the hook 130 when the hook 130 is in the retracted position shown in FIG. 10. The curved arm 142 of the hook 130 includes a finger grip pad 144 extending in a proximal direction.

The base 146 of the hook 130 is attached to a rod 148 that extends through a cylinder 150 to a piston 152. The hook 130 is slidable along a longitudinal axis 154 between a retracted position shown in FIG. 10 in an extended position shown in FIG. 11. A spring 156 impinges upon the piston 152 to create a bias in a distal direction, such that the hook 130 remains in the retracted position until an operator counteracts the bias by pulling the finger grip pad 144 in a proximal direction, thereby separating the tip 138 of the restraining bar 132 and the tip 140 of the hook 130.

In operation, a fishing lure is first enclosed within a protective case 136. The operator then aligns the hook 130 with a line guide 162 of a rod 164. Next, the operator grasps the finger grip pad 144 and pulls it in a proximal direction, thereby creating a gap 168 between the tip 138 of the restraining bar 132 and the tip 140 of the hook 130. The line guide 162 is affixed to the hook 130 by moving it through the gap 168 and releasing the finger grip pad 144 so that the hook 130 returns to the retracted position, thereby closing the gap 168. As a result, the fishing lure protective case is prevented from disengaging a line guide if the fishing line become slack.

Those skilled in the art will appreciate that the various components shown and described in throughout the Figures may be combined together in any combination, and the present invention is not limited to the permutations of components explicitly shown in the drawings. Similarly, those skilled in the art will appreciate that there are a variety of mechanisms suitable for use as a lock for releasably securing the two sections of the protective case 90 together. Similarly, several different hinge mechanisms are suitable for use as a hinge in the present invention.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A fishing lure protective case comprising:
a protective shell configured to enclose a fishing lure and extending along a longitudinal axis from a proximal end to a distal end, the protective shell having a longitudinal seam dividing the protective shell into a first section and a second section;
a hinge connecting the first and second sections of the protective shell, the hinge rotatable about an axis that substantially parallel to the longitudinal axis and the longitudinal seam of the protective shell, thereby allowing the protective shell to translate between an open position where the two sections are separated, and a closed position where the two sections are joined to close the protective shell;
an opening at the distal end of the protective shell sized to admit a fishing line and formed when the first and second sections of the protective shell are joined in the closed position;
a first hook extending from the protective shell configured to engage a line guide on a fishing rod, the hook having a blunt end; and,
a releasable locking mechanism opposite to the hinge for releasably securing the first section and the second section together when the protective shell is in the closed position.

2. The fishing lure protective case of claim 1 wherein the protective shell has a plurality of water drainage openings sized such that a fishhook on an enclosed fishing lure may not extend through the openings.

3. The fishing lure protective case of claim 2 wherein the protective shell has an ovoid shape and is substantially transparent.

4. The fishing lure protective case of claim 3 wherein the ovoid shell is formed from a single unitary piece of material.

5. The fishing lure protective case of claim 4 wherein the first hook is located at a distal end of the hinge.

6. The fishing lure protective case of claim 4 wherein the first hook is located at a distal end of the protective shell.

7. The fishing lure protective case of claim 6 wherein the first hook extends from the first section of the protective shell and a second hook coextensive and congruent to the first hook extends from the second section of the protective shell.

8. The fishing lure protective case of claim 4 wherein the protective shell is elastic and deformable.

9. The fishing lure protective case of claim 4 further comprising:
a restraining bar extending from a proximal end of the protective shell to a tip of the first hook;
a finger grip pad extending in a proximal direction from the first hook;
wherein the first hook is slidable along a longitudinal axis and is biased in a distal direction such that a gap is created between the restraining bar and the tip of the first hook only when the hook is pulled in a proximal direction.

10. The fishing lure protective case of claim 9 wherein the bias in the distal direction is applied to the first hook by a spring impinging upon a piston extending from the base of the first hook.
